(19) United States
(12) Patent Application Publication
(10) Pub. No.: US 2022/0317593 A1
(43) Pub. Date: Oct. 6, 2022

(54) TONER STORAGE CONTAINER AND IMAGE FORMING APPARATUS

(71) Applicant: Konica Minolta, Inc., Tokyo (JP)

(72) Inventors: HIDEJI HIGASHIMURA, Toyokawa-shi (JP); TAKERU KINOSHITA, Toyokawa-shi (JP)

(21) Appl. No.: 17/692,884

(22) Filed: Mar. 11, 2022

(30) Foreign Application Priority Data
Apr. 2, 2021 (JP) 2021-063527

(51) Int. Cl. G03G 15/08

(52) U.S. Cl. CPC G03G 15/0886

(57) ABSTRACT

A toner storage container detachable from an image forming apparatus includes: a bottle part that stores toner; a discharge opening that opens the bottle part to the outside; a first shutter member rotatably attached to the bottle part between a closed position and an open position; a second shutter member relatively movable with respect to the bottle part in an attachment/detachment direction in which the second shutter member is attached to or detached from the image forming apparatus between a storage position separated from the first shutter member at the open position and a detachment position in contact with the first shutter member at the closed position; and a lock mechanism that regulates movement of the second shutter member at the detachment position from the detachment position, wherein the lock mechanism includes a connection member having an inclined surface inclined with respect to the attachment/detachment direction.

The entire disclosure of Japanese patent Application No. 2021-063527, filed on Apr. 2, 2021, is incorporated herein by reference in its entirety.

### BACKGROUND

### Technological Field

The present invention relates to a toner storage container detachable from an image forming apparatus, and an image forming apparatus that forms an image on a recording medium using toner supplied from the toner storage container.

### Description of the Related Art

An image forming apparatus represented by a multi function peripheral (MFP) includes a developing device that develops an electrostatic latent image formed on a photoreceptor drum with toner, and a toner storage container that stores the toner to be supplied to the developing device. The toner storage container is detachable from the image forming apparatus. The toner storage container has an opening connected to the developing device, and the opening is closed so that the toner stored in the toner storage container is not discharged from the opening when the toner storage container is attached or detached.

For example, JP 2010-32670 A discloses a developer container that opens a main body side shutter installed in a developer storage part of a main body of an image forming apparatus to supply or collect a developer to or from the developer storage part and is detachably installed in the developer storage part, the developer container including: a container side shutter that opens and closes an opening for discharging or feeding a developer to an inside of the container; and a lock mechanism that parks the container side shutter at a position where the opening is closed, in which the lock mechanism is released in conjunction with an attachment operation to the developer storage part, the container side shutter opens the opening, the container side shutter closes the opening in conjunction with a detachment operation from the developer storage part, and the container side shutter is parked by the lock mechanism, and the lock mechanism includes: a protruding part installed in the vicinity of the opening; and a claw member installed in the container side shutter and engaged with the protruding part to regulate movement of the container side shutter in an opening direction, wherein after the claw member is elastically deformed by abutment with the developer storage part in conjunction with an operation of setting the developer storage part from above or below to release the engagement between the claw member and the protruding part, the opening is opened in a state where the container side shutter is fixed in conjunction with an operation of pushing the developer storage part forward, and the main body side shutter is pushed to communicate the opening with the main body side opening of the developer storage part, and, after the opening is closed by the container side shutter fixed in conjunction with the operation of pulling out the developer storage part rearward and the main body side shutter is closed, the elastic deformation of the claw member due to the abutment with the developer storage part is released in conjunction with the operation of detaching the developer storage part upward or downward, and the claw member and the protruding part are engaged with each other.

However, in the developer container described in JP 2010-32670 A, when the developer container is attached to and detached from the developer storage part, the lock mechanism is enabled or released in conjunction with the operation of setting the developer container from the vertical direction, and the container side shutter is opened and closed in conjunction with the operation of pushing the developer container forward or the operation of pulling the developer container backward. Therefore, when attaching and detaching the developer container to and from the developer storage part, the user is forced to perform an operation of moving the developer container in the vertical direction and an operation of moving the developer container in the front-rear direction. Therefore, it is necessary to move the developer container in two different directions, and the operation is complicated.

### SUMMARY

The present invention has been made to solve the above-described problems, and an object of the present invention is to provide a toner storage container capable of reducing toner that falls down while not being stored in an image forming apparatus and storing the toner in the image forming apparatus by applying a unidirectional force.

Another object of the present invention is to provide an image forming apparatus capable of storing a toner storage container by moving the toner storage container in one direction with less toner falling down.

To achieve at least one of the abovementioned objects, according to an aspect of the present invention, a toner storage container detachable from an image forming apparatus reflecting one aspect of the present invention comprises: a bottle part that stores toner; a discharge opening that opens the bottle part to the outside; a first shutter member that is rotatably attached to the bottle part between a closed position where the discharge opening is closed and an open position where the discharge opening is opened; a second shutter member that is provided to be relatively movable with respect to the bottle part in an attachment/detachment direction in which the second shutter member is attached to or detached from the image forming apparatus between a storage position separated from the first shutter member at the open position and a detachment position in contact with the first shutter member at the closed position; and a lock mechanism that regulates movement of the second shutter member at the detachment position from the detachment position, wherein the lock mechanism includes a connection member having an inclined surface inclined with respect to the attachment/detachment direction in a state where the second shutter member is located at the storage position.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a first perspective view illustrating an appearance of an MFP according to one embodiment of the present invention;

FIG. 2 is a cross-sectional view schematically illustrating an example of an internal configuration of the MFP;

FIG. 3 is a perspective view illustrating an appearance of a toner storage container and a sub-hopper;

FIG. 4 is a second perspective view illustrating an appearance of an MFP according to one embodiment of the present invention;

FIG. 5 is a view illustrating a state in which a toner storage container is replaced in the MFP;

FIG. 6 is a first perspective view illustrating a part of an example of the toner storage container;

FIG. 7 is a second perspective view illustrating a part of an example of the toner storage container;

FIG. 8 is a plan view of a second shutter member in a state at a storage position;

FIG. 9 is a cross-sectional view of a part of the toner storage container in a state where the second shutter member is located at the storage position:

FIG. 10 is a cross-sectional view of a part of the toner storage container in a state where the second shutter member is located at a detachment position;

FIG. 11 is an enlarged perspective view illustrating a part of the container storage part together with peripheral members;

FIG. 12 is a first view illustrating a positional relationship among a cap part, a second shutter member, and a side guide plate;

FIG. 13 is a second view illustrating a positional relationship among the cap part, the second shutter member, and the side guide plate;

FIG. 14 is a third view illustrating a positional relationship among the cap part, the second shutter member, and the side guide plate;

FIG. 15 is a fourth view illustrating a positional relationship among the cap part, the second shutter member, and the side guide plate;

FIG. 16 is a fifth view illustrating a positional relationship among the cap part, the second shutter member, and the side guide plate;

FIG. 17 is a first perspective view illustrating a part of an example of a toner storage container in a modification;

FIG. 18 is a second perspective view illustrating a part of an example of a toner storage container in a modification;

FIG. 19 is a plan view of a regulating member in a state where the second shutter member is at the detachment position;

FIG. 20 is an enlarged perspective view illustrating a part of a container storage part in a modification together with peripheral members;

FIG. 21 is a first view illustrating a positional relationship among a regulating member, a second shutter member, and a guide member;

FIG. 22 is a second view illustrating a positional relationship among the regulating member, the second shutter member, and the guide member; and

FIG. 23 is a third view illustrating a positional relationship among the regulating member, the second shutter member, and the guide member.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are denoted by the same reference numerals. Their names and functions are the same. Therefore, the detailed description thereof will not be repeated.

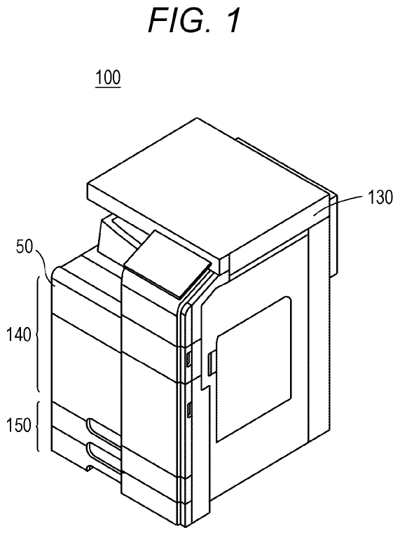

FIG. 1 is a first perspective view illustrating an appearance of an MFP according to one embodiment of the present invention. Referring to FIG. 1, a multi function peripheral (MFP) 100 is an example of an image forming apparatus, and includes a cover member 50 constituting a part of a main body case on a front surface thereof. The cover member 50 is openable and closable, and FIG. 1 illustrates the MFP 100 in a closed state in which the cover member 50 is closed. Hereinafter, a horizontal direction from the rear surface to the front surface of the MFP 100 is referred to as a front direction, and a horizontal direction from the front surface to the rear surface is referred to as a rear direction.

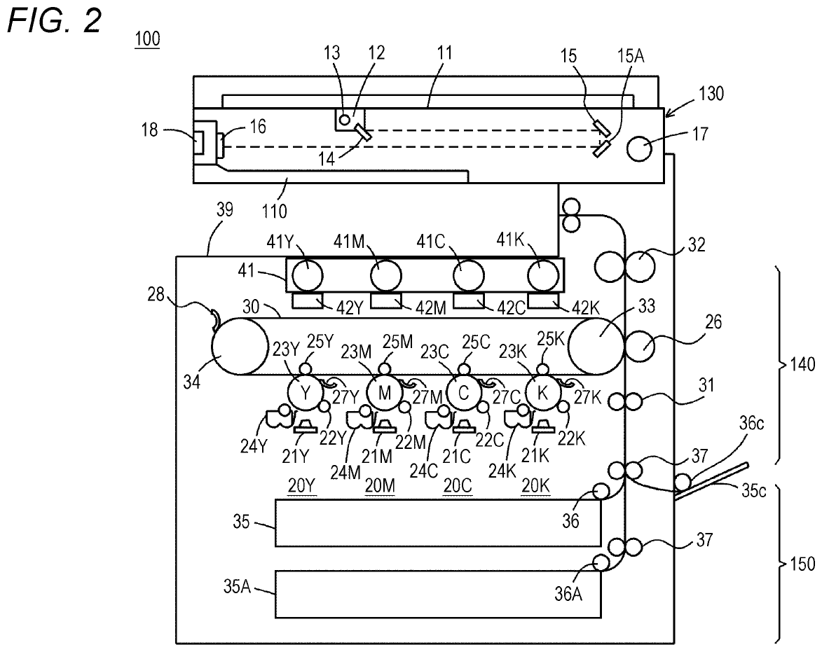

FIG. 2 is a cross-sectional view schematically illustrating an example of an internal configuration of the MFP. Referring to FIGS. 1 and 2, the MFP 100 includes a document reading part 130 that reads a document, an image forming part 140 that forms an image on a sheet on the basis of image data, and a sheet feeding part 150 that supplies a sheet to the image forming part 140.

The document reading part 130 exposes an image of a document set on a document glass 11 with an exposure lamp 13 attached to a slider 12 moving below the document. Reflected light from the document is guided to a lens 16 by a mirror 14 and two reflection mirrors 15 and 15A, and forms an image on a charge coupled devices (CCD) sensor 18.

The reflected light that has formed an image on the CCD sensor 18 is converted into image data as an electric signal in the CCD sensor 18. The image data is converted into printing data of cyan (C), magenta (M), yellow (Y), and black (K) and output to the image forming part 140.

The image forming part 140 includes image forming units 20Y, 20M, 20C, and 20K of yellow, magenta, cyan, and black, respectively. Here, “Y”, “M”, “C” and “K” represent yellow, magenta, cyan, and black, respectively. At least one of the image forming units 20Y, 20M, 20C, and 20K is driven to form an image. When all of the image 1 units 20Y, 20M, 20C, and 20K are driven, a full-color image is formed. Printing data of yellow, magenta, cyan, and black is input to the image forming units 20Y, 20M, 20C, and 20K, respectively. Since the image forming units 20Y, 20M, 20C, and 20K are different only in colors of toner to be handled, the image forming unit 20Y for forming a yellow image will be described here.

The image forming unit 20Y includes an exposure device 21Y to which yellow printing data is input, a photoreceptor drum 23Y as an image carrier, a charging roller 22Y for uniformly charging the surface of the photoreceptor drum 23Y, a developing device 24Y, a primary transfer roller 25Y for transferring a toner image formed on the photoreceptor drum 23Y onto an intermediate transfer belt 30 as an image carrier by the action of an electric field force, a drum cleaning blade 27Y for removing transfer residual toner on the photoreceptor drum 23Y, a toner storage container 41Y, and a sub-hopper 42Y.

The toner storage container 41Y stores yellow toner. The toner storage container 41Y is stored in a container storage part 41 provided in a main body frame, is driven by a toner storage container motor provided in the main body frame as a drive source, and discharges the toner to the outside. The toner discharged from the toner storage container 41Y is supplied to the sub-hopper 42Y. The sub-hopper 42Y is provided below the container storage part 41, and includes a toner storage portion that temporarily stores the toner discharged from the toner storage container 41Y between the toner storage container 41Y and the developing device 24Y. The sub-hopper 42Y supplies the toner stored in the toner storage portion to the developing device 24Y in response to the remaining amount of the toner stored in the developing device 24Y becoming equal to or less than a predetermined lower limit value.

A charging roller 22Y, an exposure device 21Y, a developing device 24Y, a primary transfer roller 25Y, and a drum cleaning blade 27Y are sequentially arranged around the photoreceptor drum 23Y along the rotation direction of the photoreceptor drum 23Y.

The photoreceptor drum 23Y is charged by the charging roller 22Y, and then irradiated with laser light emitted by the exposure device 21Y. The exposure device 21Y exposes an image corresponding portion on the surface of the photoreceptor drum 23Y. As a result, an electrostatic latent image is formed on the photoreceptor drum 23Y. Subsequently, the developing device 24Y develops the electrostatic latent image formed on the photoreceptor drum 23Y with charged toner. Specifically, the toner is placed on the electrostatic latent image formed on the photoreceptor drum 23Y by the action of the electric field force, whereby the toner image is formed on the photoreceptor drum 23Y. The toner image formed on the photoreceptor drum 23Y is transferred onto the intermediate transfer belt 30 as an image carrier by the action of an electric field force by the primary transfer roller 25Y. The toner remaining without being transferred on the photoreceptor drum 23Y is removed from the photoreceptor drum 23Y by the drum cleaning blade 27Y.

On the other hand, the intermediate transfer belt 30 is suspended by a driving roller 33 and a driven roller 34 so as not to be loosened. When the driving roller 33 rotates counterclockwise in FIG. 2, the intermediate transfer belt 30 rotates counterclockwise in FIG. 2 at a predetermined speed. As the intermediate transfer belt 30 rotates, the driven roller 34 rotates counterclockwise.

As a result, the image forming units 20Y, 20M, 20C, and 20K sequentially transfer the toner images onto the intermediate transfer belt 30. The timing at which each of the image forming units 20Y, 20M, 20C, and 20K transfers the toner image onto the intermediate transfer belt 30 is adjusted on the basis of detection of a reference mark attached to the intermediate transfer belt 30. As a result, yellow, magenta, cyan, and black toner images are superimposed on the intermediate transfer belt 30.

The toner image formed on the intermediate transfer belt 30 is transferred to the sheet by the action of the electric field force by a secondary transfer roller 26 which is a transfer member. The sheet conveyed by a timing roller 31 is conveyed to a nip portion where the intermediate transfer belt 30 and the secondary transfer roller 26 are in contact with each other. The sheet to which the toner image has been transferred is conveyed to a fixing roller 32, and is heated and pressurized by the fixing roller 32. As a result, the toner is melted and fixed to the sheet. Thereafter, the sheet is discharged to a sheet discharge tray 39.

A belt cleaning blade 28 is provided upstream of the image forming unit 20Y of the intermediate transfer belt 30. The belt cleaning blade 28 removes toner remaining on the intermediate transfer belt 30 without being transferred to the sheet.

Sheets of different sizes are set in sheet feeding cassettes 35 and 35A, respectively. The sheets stored in the sheet feeding cassettes 35 and 35A are supplied to the conveyance path by take-out rollers 36 and 36A attached to the sheet feeding cassettes 35 and 35A, respectively, and are sent to the timing roller 31 by a sheet feeding roller 37.

The MFP 100 drives all of the image forming units 20Y, 20M, 20C, and 20K in the case of forming a full-color image, but drives any one of the image forming units 20Y. 20M, 20C, and 20K in the case of forming a monochrome image. Further, it is also possible to form an image by combining two or more of the image forming units 20Y, 20M, 20C, and 20K. Note that, here, an example will be described in which the MFP 100 employs a tandem system including the image forming units 20Y, 20M, 20C, and 20K that form toners of four colors on a sheet, respectively. However, a four-cycle system in which toners of four colors are sequentially transferred to a sheet on one photoreceptor drum may be employed.

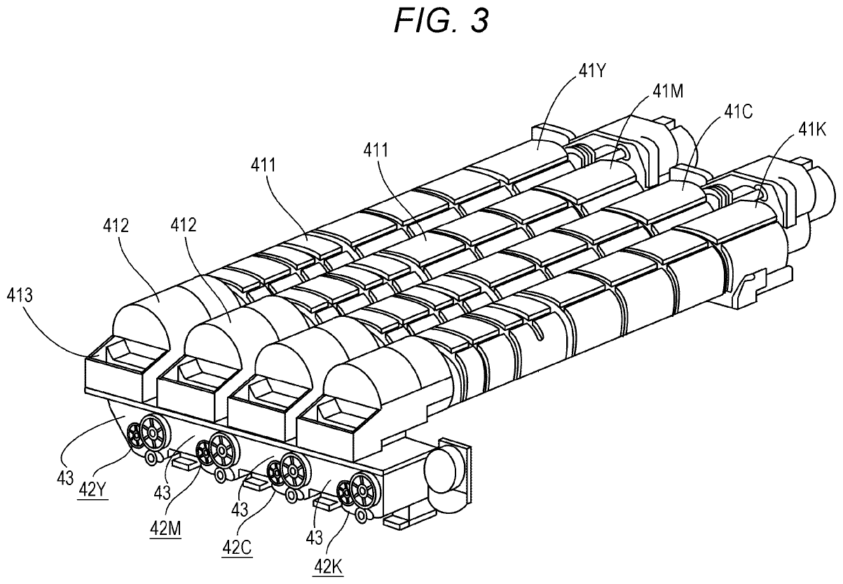

FIG. 3 is a perspective view illustrating an appearance of a toner storage container and a sub-hopper. Referring to FIG. 3, each of toner storage containers 41Y, 41M, 41C, and 41K includes a bottle part 411 that stores toner and a cap part 412 attached to one end of the bottle part 411. Sub-hoppers 42Y, 42M, 42C, and 42K are integrally provided corresponding to the toner storage containers 41Y, 41M, 41C, and 41K, respectively. In a state where the toner storage containers 41Y, 41M, 41C, and 41K are stored in the container storage part 41 of the MFP 100, the toner storage containers 41Y, 41M, 41C, and 41K and the sub-hoppers 42Y. 42M, 42C, and 42K are relatively positioned.

Each of the sub-hoppers 42Y, 42M, 42C, and 42K has a hollow structure and includes a toner storage portion 43 for storing toner therein.

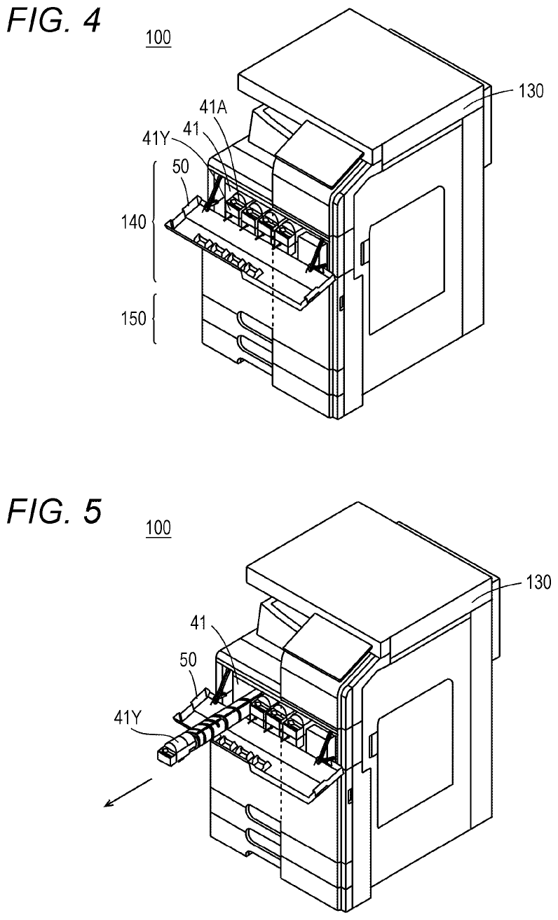

FIG. 4 is a second perspective view illustrating an appearance of the MFP in one embodiment of the present invention. Referring to FIG. 4, FIG. 4 illustrates the MFP 100 in an open state in which the cover member 50 is opened. In the open state, the cover member 50 exposes a storage opening 41A of the container storage part 41 of the image forming part 140 to the outside. In the open state of the cover member 50, its rear surface, the surface facing the inside of the MFP 100 in the closed state of the cover member 50 faces upward. The storage opening 41A is an opening on the front side of the container storage part 41, and is a part that first receives the toner storage containers 41Y, 41M. 41C, and 41K when the toner storage containers 41Y, 41M, 41C, and 41K are inserted into the container storage part 41. In FIG. 4, since a state in which the toner storage containers 41Y, 41M, 41C, and 41K are stored in the container storage part 41 is illustrated, the storage opening 41A is hidden by the toner storage containers 41Y, 41M, 41C, and 41K and cannot be seen.

In the open state of the cover member 50, parts other than a part of the toner storage containers 41Y, 41M, 41C, and 41K and the sub-hoppers 42Y, 42M, 42C, and 42K of the image forming units 20Y, 20M, 20C, and 20K are not exposed to the outside. Therefore, in the open state of the cover member 50, the image forming part 140 is set to be capable of executing an image forming operation. Therefore, even when the cover member 50 is changed from the closed state to the open state during the image forming operation of the image forming part 140, the image forming part 140 continues the image forming operation without interrupting the image forming operation. In addition, since the container storage part 41 is exposed in the open state of the cover member 50, the user can replace at least one of the toner storage containers 41Y, 41M, 41C, and 41K.

FIG. 5 is a view illustrating a state in which a toner storage container is replaced in the MFP. Referring to FIG. 5, the toner storage container 41Y is detached from the MFP 100 by being pulled out in the front direction from the container storage part 41 of the MFP 100. Thereafter, a new toner storage container 41Y is attached to the MFP 100 by being pushed into the container storage part 41 of the MFP 100 in the rear direction. The toner storage container 41Y is attached and detached in the open state of the cover member 50, and the toner storage container 41Y passes above the cover member 50 at the time of attachment and detachment.

The toner storage container 41Y is inserted into the container storage part 41 of the MFP 100 in a longitudinal direction. Hereinafter, the longitudinal direction in which the toner storage container 41Y is inserted into the container storage part 41 of the MFP 100 is referred to as an attachment/detachment direction. The attachment/detachment direction includes a front direction and a rear direction.

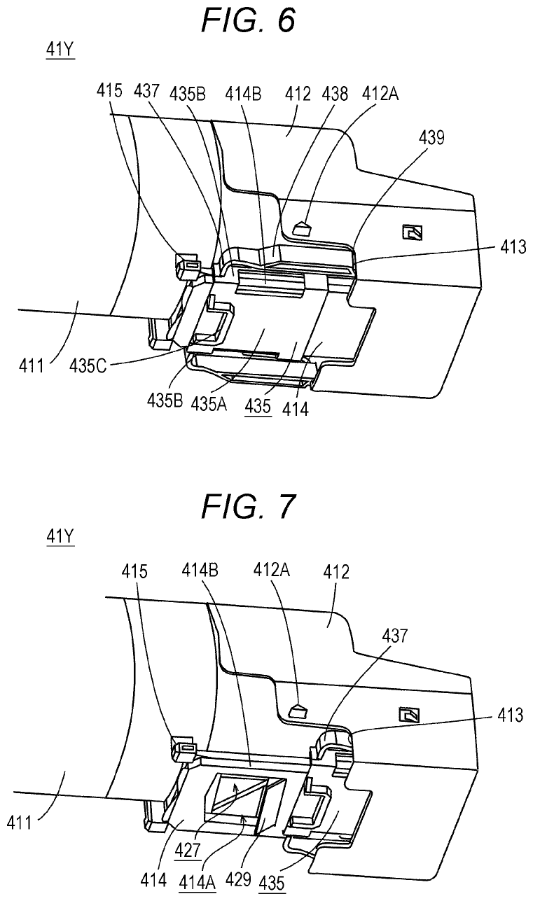

FIG. 6 is a first perspective view illustrating a part of an example of the toner storage container. FIG. 7 is a second perspective view illustrating a part of an example of the toner storage container. FIGS. 6 and 7 are views of the toner storage container 41Y as viewed from obliquely below on the front side. Referring to FIGS. 6 and 7, the toner storage container 41Y includes the bottle part 411 that stores toner, a discharge opening 427 that opens the bottle part 411 to the outside, a first shutter member 429 that opens and closes the discharge opening 427, a second shutter member 435, a support member 414 to which the second shutter member is attached, and the cap part 412. The cap part 412 includes protruding parts 412A protruding in the horizontal direction on side walls constituting both side surfaces, and locking parts 413 formed on the side walls of the cap part 412. The side walls of the cap part 412 define a space for storing a part of the second shutter member 435. The locking parts 413 constitute a part of a lock mechanism.

FIG. 6 illustrates a state in which the second shutter member 435 is located at the detachment position, and FIG. 7 illustrates a state in which the second shutter member 435 is located at the storage position. The second shutter member 435 is attached to the bottle part 411 so as to be relatively movable with respect to the bottle part 411 in the attachment/detachment direction.

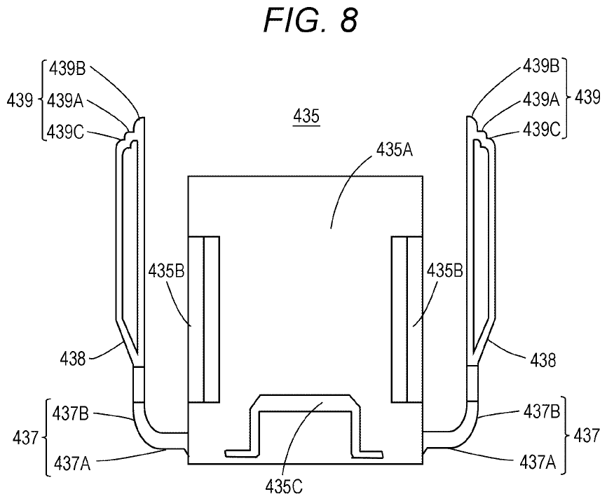

FIG. 8 is a plan view of the second shutter member in a state at the storage position. FIG. 8 is a plan view of the second shutter member 435 as viewed from below. In FIG. 8, the vertical direction is the attachment/detachment direction, the upper side in the drawing is the front direction, and the lower side in the drawing is the rear direction. The second shutter member 435 includes a lid member 435A having a rectangular flat plate shape, a pair of gripping parts 435B extending upward from two opposing ends of the lid member 435A, and a protruding part 435C extending downward from a lower surface of the lid member 435A. The pair of gripping parts 435B has grooves extending in the attachment/detachment direction formed on the surfaces facing each other.

Connection members 437 having engaging parts 439 formed therein are connected to the gripping parts 435B on both sides of the second shutter member 435, respectively. The connection member 437 connects the second shutter member 435 and the engaging part 439. The connection member 437 and the engaging part 439 constitute a part of the lock mechanism. The second shutter member 435 is disposed between the two engaging parts 439 in a direction intersecting the attachment/detachment direction. In the present embodiment, the second shutter member 435, the connection member 437, and the engaging part 439 are formed of the same member.

Specifically, the connection member 437 includes a base bottom portion 437A extending from the gripping part 435B in a direction opposite to the second shutter member 435 and an arm portion 437B extending from an end of the base bottom portion 437A in the front direction. The engaging part 439 is formed at an end of the arm portion 437B opposite to an end connected to the base bottom portion 437A. The engaging part 439 is formed on a sliding surface facing a surface of the arm portion 437B facing the second shutter member 435, and has an engaging surface 439A intersecting with the sliding surface and two sliding surfaces 439B and 439C sandwiching the engaging surface 439A in the attachment/detachment direction. Among the two sliding surfaces 439B and 439C, the sliding surface 439B located on a side (front direction side) in a direction in which the second shutter member 435 moves from the detachment position to the storage position has a shorter distance from the second shutter member 435 in a state where the second shutter member 435 is located at the detachment position. The sliding surface 439B has a predetermined length in the attachment/detachment direction. The base bottom portion 437A and the arm portion 437B have elasticity, and bias the engaging part 439 in a direction away from the second shutter member 435. Therefore, the engaging part 439 can be engaged with the locking part 413.

The engaging surface 439A is perpendicular to the attachment/detachment direction in a state where the second shutter member 435 is at the storage position. Here, the engaging surface 439A is a surface perpendicular to the attachment/detachment direction, but the present invention is not limited thereto, and the engaging surface 439A desirably has a surface parallel to the locking part 413 described later.

The arm portion 437B has an inclined surface 438 that intersects the attachment/detachment direction between the end connected to the base bottom portion 437A and the engaging part 439. The inclined surface 438 has a longer distance from the second shutter member 435 at a part as it goes toward the front direction. Therefore, when the inclined surface 438 receives a force in the front direction, the base bottom portion 437A and the arm portion 437B are elastically deformed, and the engaging part 439 moves in a direction approaching the second shutter member 435. In this case, the engaging part 439 is not engaged with the locking part 413.

Referring to FIG. 7 again, the bottle part 411 includes the support member 414 disposed below the discharge opening 427 and a shutter regulating part 415 disposed adjacent to the support member 414 on the rear direction side. The support member 414 is located vertically below the discharge opening 427, and a hole 414A having a size equal to or larger than a region obtained by projecting the discharge opening 427 on a horizontal plane vertically below is formed.

The grooves formed in the pair of gripping parts 435B of the second shutter member 435 are respectively engaged with a pair of ends 414B which are end surfaces parallel to the attachment/detachment direction of the support member 414. As a result, the second shutter member 435 is slidable in the attachment/detachment direction with respect to the support member 414.

As illustrated in FIG. 6, in a state where the second shutter member 435 is located at the detachment position, the movement of the second shutter member 435 in the front direction is regulated by the lock mechanism. The lock mechanism includes the locking parts 413 formed on the cap part 412, the connection members 437, and the engaging parts 439. Specifically, the engaging parts 439 of the second shutter member 435 are engaged with the locking parts 413 formed on the cap part 412, and the movement of the second shutter member 435 from the detachment position to the storage position is regulated. In addition, the second shutter member 435 closes the hole 414A formed in the support member 414. Therefore, the toner stored in the bottle part 411 does not leak and fall from the toner storage container 41Y.

As illustrated in FIG. 7, in a state where the second shutter member 435 is located at the storage position, a part of the second shutter member 435 is stored in the internal space of the cap part 412. In addition, the first shutter member 429 opens the discharge opening 427, and the hole 414A formed in the support member 414 is exposed. Since the hole 414A formed in the support member 414 has a size equal to or larger than a region obtained by projecting the discharge opening 427 on the horizontal plane vertically below, the toner falling from the discharge opening 427 of the bottle part 411 passes through the hole 414A and falls downward. Therefore, the toner stored in the bottle part 411 falls from the discharge opening 427 by gravity.

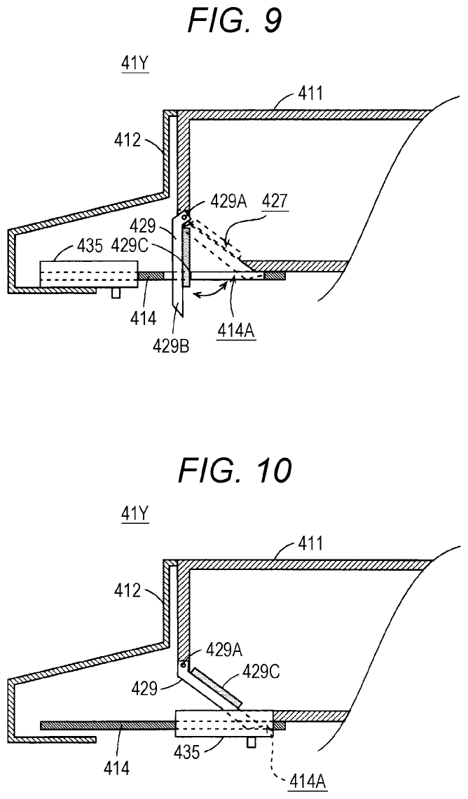

FIG. 9 is a cross-sectional view of a part of the toner storage container in a state where the second shutter member is located at the storage position. FIG. 10 is a cross-sectional view of a part of the toner storage container in a state where the second shutter member is located at the detachment position.

The first shutter member 429 has a flat plate shape and has a rotation shaft 429A at one end, and the rotation shaft 429A is pivotally supported by the bottle part 411 at an end of the discharge opening 427 in the front direction. The first shutter member 429 is rotatable between the closed position and the open position about the rotation shaft 429A. The closed position is a position where the discharge opening 427 is closed and the bottle part 411 is closed. The open position is a position where the discharge opening 427 is opened and the bottle part 411 is opened to the outside. The first shutter member 429 has a sheet 429C having elasticity attached to a surface facing the bottle part 411. The sheet 429C is an elastic body, and may be, for example, rubber or sponge-like urethane. Therefore, the toner can be prevented from leaking and falling from the discharge opening 427 as much as possible in a state where the first shutter member 429 is located at the closed position.

The rotation shaft 429A of the first shutter member 429 is always located above the center of gravity of the first shutter member 429 while the first shutter member 429 rotates between the closed position and the open position. In addition, with respect to a contact end 429B that is an end of the first shutter member 429 on the opposite side of the rotation shaft 429A, the position at the closed position is located above the position at the open position. Therefore, the first shutter member 429 moves from the closed position to the open position by being rotated by its own weight. At the open position, the surface of the first shutter member 429 on the side on which the discharge opening 427 is closed is vertical. In addition, the first shutter member 429 rotates toward the closed position by receiving a force in the rear direction from the outside in a state of being located at the open position.

In a state where the second shutter member 435 is at the storage position, the first shutter member 429 is at the open position, and the upper surface of the lid member 435A of the second shutter member 435 is located above the contact end 429B of the first shutter member 429. In a case where the second shutter member 435 moves in the rear direction in the attachment/detachment direction with respect to the bottle part 411 from the state where the second shutter member 435 is at the storage position, the second shutter member 435 abuts on the first shutter member 429, and the first shutter member 429 rotates with the contact end 429B lifted upward. Thereafter, when the contact end 429B of the first shutter member 429 ascends to the position of the upper surface of the lid member 435A of the second shutter member 435, the first shutter member 429 comes to the closed position. The second shutter member 435 further moves in the rear direction in the attachment/detachment direction with respect to the bottle part 411, abuts on the shutter regulating part 415 of the bottle part 411, and stops at the attachment/detachment position. During this time, the contact end 429B of the first shutter member 429 is abutting on the upper surface of the lid member 435A of the second shutter member 435, and the closed state of the first shutter member 429 is maintained.

When the second shutter member 435 moves from the attachment/detachment position in the front direction in the attachment/detachment direction with respect to the bottle part 411, the contact end 429B of the first shutter member 429 is not in contact with the upper surface of the lid member 435A of the second shutter member 435. When the contact end 429B of the first shutter member 429 is not in contact with the upper surface of the lid member 435A of the second shutter member 435, the contact end 429B of the first shutter member 429 starts to move downward, and the first shutter member 429 starts to rotate by its own weight about the rotation shaft 429A. The first shutter member 429 stops at the storage position where the surface of the first shutter member 429 facing the discharge opening 427 is vertical. Note that the second shutter member 435 may be separated from the first shutter member 429 at the storage position.

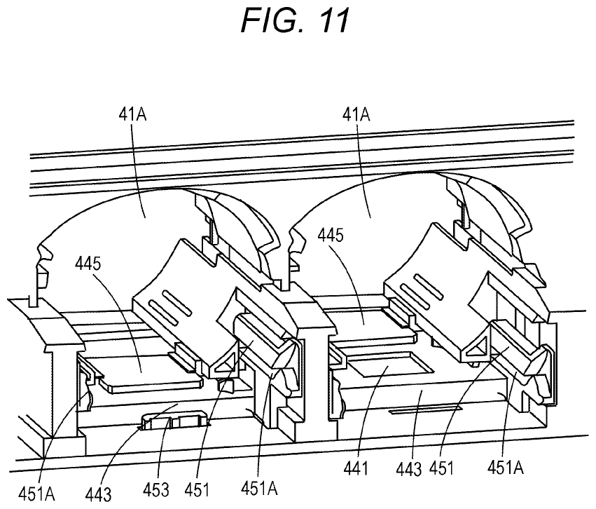

FIG. 11 is an enlarged perspective view illustrating a part of the container storage part together with peripheral members. FIG. 11 illustrates a part corresponding to the storage opening 41A in which each of the toner storage containers 41Y and 41M of the container storage part 41 is stored. Referring to FIG. 11, the regulating part 443 is disposed below the storage opening 41A of the container storage part 41, and a regulating claw 453 is disposed on the front direction side of the regulating part 443 at a predetermined distance. The regulating part 443 is a part of the front wall on the front direction side of each of the sub-hoppers 42Y, 42M, 42C, and 42K. The regulating claw 453 is provided to be movable in the vertical direction. The regulating claw 453 is formed of the same member as a pair of side guide plates 451. The pair of side guide plates 451 has sliding grooves 451A formed on surfaces facing each other.

The container storage part 41 has a cylindrical space having a diameter larger than the outer diameter of the toner storage container 41Y. When the user inserts the end of the toner storage container 41Y in the rear direction into the storage opening 41A and pushes the toner storage container 41Y in the rear direction, the toner storage container 41Y enters the container storage part 41. In a state where a part having a predetermined length of the toner storage container 41Y enters the container storage part 41, a direction intersecting the attachment/detachment direction of the toner storage container 41Y is positioned by the container storage part 41.

While the toner storage container 41Y is being inserted into the container storage part 41, the protruding parts 412A (see FIG. 6) formed on the side walls of both side surfaces of the cap part 412 of the toner storage container 41Y enter the sliding grooves 451A formed in the side guide plates 451. Since the toner storage container 41Y moves in the attachment/detachment direction, the protruding parts 412A also move in the attachment/detachment direction along with the movement of the toner storage container 41Y. Therefore, the sliding groove 451A formed in the side guide plate 451 receives a force from the protruding part 412A, and the regulating claw 453 moves in the vertical direction.

The sliding groove 451A is formed in the side guide plate 451 so that the sliding groove 451A is positioned on the lower side until the second shutter member 435 abuts on the regulating part 443 after the toner storage container 41Y enters the container storage part 41, and the regulating claw 453 is positioned on the upper side after the second shutter member 435 abuts on the regulating part 443.

FIG. 11 illustrates a state in which the regulating claw 453 corresponding to the storage opening 41A of the container storage part 41 in which the toner storage container 41Y is stored is positioned on the upper side, and illustrates a state in which the regulating claw 453 corresponding to the storage opening 41A of the container storage part 41 in which the toner storage container 41M is stored is positioned on the lower side.

As illustrated in FIG. 11, a supply opening 441 for opening the toner storage portion 43 to the outside is formed on the upper surface of the sub-hopper 42Y. In addition, a state in which the supply opening 441 of the sub-hopper 42Y is closed by a closing plate 445 is shown. The closing plate 445 is biased in the front direction by an elastic body such as a spring, and the shutter regulating part 415 provided in the toner storage container 41Y abuts on the closing plate 445 while the toner storage container 41Y is inserted into the container storage part 41, and the closing plate 445 is moved by being pushed in the rear direction by the shutter regulating part 415 to open the supply opening 441.

Note that FIG. 11 illustrates a state in which the supply opening 441 is opened and a state in which the regulating claw 453 is moved downward in the storage opening 41A of the container storage part 41 in which the toner storage container 41M is stored, however in practically, it is not necessary to realize two states at the same time. When the toner storage container 41Y is stored in the container storage part 41, the regulating claw 453 may move downward only while at least the protruding part 435C provided on the second shutter member 435 moves from the front direction side to the rear direction with respect to the regulating claw 453, and when the toner storage container 41Y is detached from the container storage part 41, the regulating claw 453 may move upward only while at least the second shutter member 435 moves from the storage position to the attachment/detachment position. In addition, the supply opening 441 may be opened only while at least the discharge opening 427 of the toner storage container 41Y is positioned above the supply opening 441.

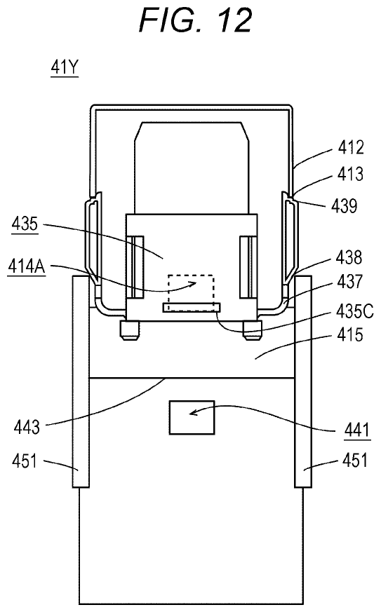

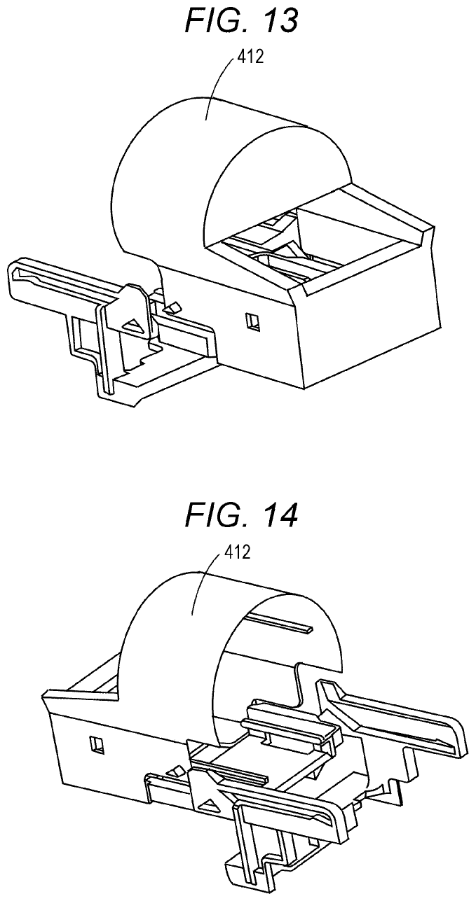

FIGS. 12 to 16 are diagrams illustrating a positional relationship among the cap part, the second shutter member, and the side guide plate. FIGS. 12 to 14 illustrate a positional relationship in a stage before the inclined surface 438 of the second shutter member 435 comes into contact with the side guide plate 451. FIG. 12 is a first view of the second shutter member 435 as viewed from below. In FIG. 12, an upper side in the drawing is the front direction, and a lower side in the drawing is the rear direction. FIG. 13 is a perspective view of the side guide plate 451, the second shutter member 435, and the cap part 412 as viewed obliquely from above on the front side. FIG. 14 is a perspective view of the side guide plate 451, the second shutter member 435, and the cap part 412 as viewed obliquely from above on the rear side.

Referring to FIGS. 12 to 14, the toner storage container 41Y is inserted into the container storage part 41 by the user from the front side in the rear direction. FIGS. 12 to 14 illustrate a state before the inclined surface 438 of the second shutter member 435 comes into contact with the side guide plate 451. In this state, the movement of the second shutter member 435 in the front direction with respect to the bottle part 411 is regulated by the lock mechanism. Specifically, since the engaging part 439 is engaged with the locking part 413 of the cap part 412, the second shutter member 435 is regulated from moving in the front direction with respect to the bottle part 411 and is fixed at the detachment position.

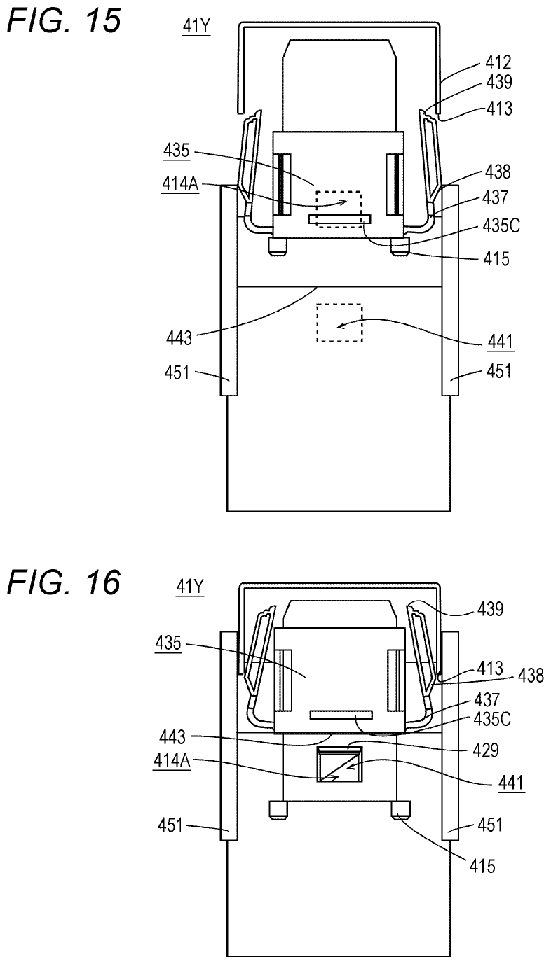

FIG. 15 illustrates a positional relationship among the cap part 412, the second shutter member 435, and the side guide plate 451 at a stage immediately after the inclined surface 438 of the connection member 437 comes into contact with the side guide plate 451. FIG. 15 is a second view of the second shutter member 435 as viewed from below. In FIG. 15, an upper side in the drawing is the front direction, and a lower side in the drawing is the rear direction. Referring to FIG. 15, a state in which the toner storage container 41Y is pushed by a predetermined amount in the rear direction by the user from the state illustrated in FIG. 12 is illustrated. When the toner storage container 41Y is pushed in the rear direction by the user from the state illustrated in FIG. 12, the inclined surface 438 formed on the connection member 437 abuts on the side guide plate 451, and the inclined surface 438 receives a force in the front direction from the side guide plate 451. As a result, the connection member 437 is elastically deformed, and the engaging part 439 moves in the direction toward the second shutter member 435 and is not engaged with the locking part 413. Since the direction intersecting the attachment/detachment direction of the toner storage container 41Y is positioned by the container storage part 41, the inclined surface 438 formed on the connection member 437 reliably abuts on the side guide plate 451. Therefore, the second shutter member 435 is movable in the front direction with respect to the bottle part 411.

When the toner storage container 41Y is further pushed in the rear direction by the user, the second shutter member 435 abuts on the regulating part 443. Since the direction intersecting the attachment/detachment direction of the toner storage container 41Y is positioned by the container storage part 41, the second shutter member 435 reliably abuts on the regulating part 443. Since the movement of the second shutter member 435 relative to the container storage part 41 is regulated by the regulating part 443, when the toner storage container 41Y is further pushed by the user in the rear direction, the second shutter member 435 starts to move from the detachment position to the storage position. While the second shutter member 435 moves from the detachment position to the storage position, the surface of the connection member 437 on the opposite side of the surface facing the second shutter member 435 moves while being in contact with the inner surface of the side wall of the cap part 412. During this time, elastic deformation of the connection member 437 is maintained, and a state in which the engaging part 439 is biased in a direction away from the second shutter member 435 is maintained.

FIG. 16 illustrates a positional relationship among the cap part 412, the second shutter member 435, and the side guide plate 451 in a state where the toner storage container 41Y is stored in the container storage part 41. FIG. 16 is a third view of the second shutter member 435 as viewed from below. In FIG. 16, an upper side in the drawing is the front direction, and a lower side in the drawing is the rear direction. When the toner storage container 41Y is pushed in the rear direction by the user and stored in the container storage part 41, the movement of the second shutter member 435 is regulated by the regulating part 443, so that the second shutter member 435 moves to the storage position.

Referring to FIG. 16, the hole 414A of the support member 414 is exposed in a state where the second shutter member 435 is at the storage position. In a state where the toner storage container 41Y is stored in the container storage part 41, the hole 414A of the support member 414 vertically overlaps the supply opening 441 of the sub-hopper 42Y. Since the sliding surface of the connection member 437 abuts on the inner surface of the side wall of the cap part 412, the second shutter member 435 is further elastically deformed, and a part of the second shutter member 435 is stored in the internal space of the cap part 412.

<Modification>

Next, a toner storage container in a modification will be described. A toner storage container 41Y in the modification is obtained by changing the above-described lock mechanism. A second shutter member 435 in the modification includes a regulating member 461 instead of the connection member 437, the engaging part 439, and the locking part 413 in the toner storage container 41Y described above.

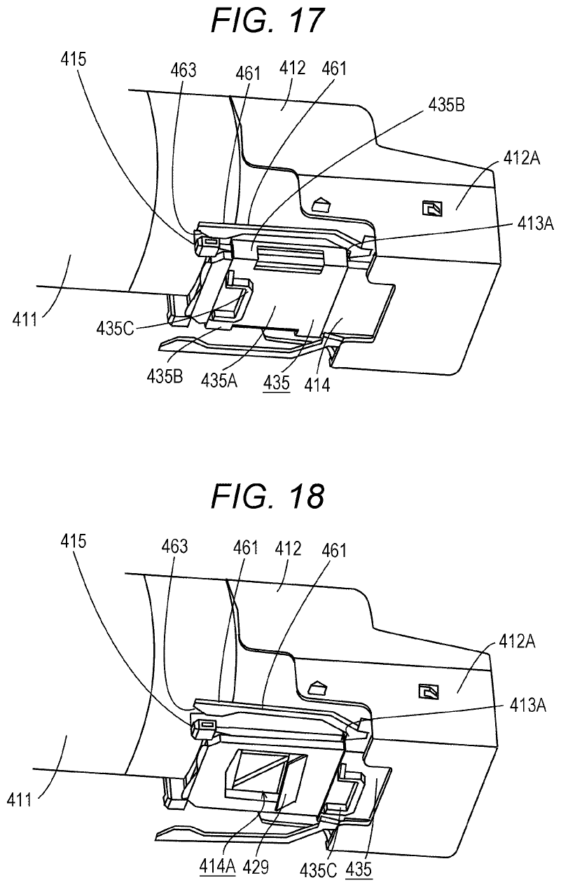

FIG. 17 is a first perspective view illustrating a part of an example of the toner storage container in the modification. FIG. 18 is a second perspective view illustrating a part of an example of the toner storage container in the modification. FIGS. 17 and 18 are views of the toner storage container 41Y as viewed from obliquely below on the front side. Referring to FIGS. 17 and 18, the toner storage container 41Y includes a bottle part 411 that stores toner, a discharge opening 427 that opens a toner storage part to the outside, a first shutter member 429 that opens and closes the discharge opening 427, a second shutter member 435, a support member 414 to which the second shutter member 435 is attached, a cap part 412, and a regulating member 461. The cap part 412 has protruding parts 412A protruding in the horizontal direction on side walls constituting both side surfaces. The side walls of the cap part 412 define a space for storing a part of the regulating member 461 and a part of the second shutter member 435. The second shutter member 435 and the regulating member 461 are formed of different members.

FIG. 17 illustrates a state in which the second shutter member 435 is located at the detachment position, and FIG. 18 illustrates a state in which the second shutter member 435 is located at the storage position. The second shutter member 435 is attached to the bottle part 411 so as to be relatively movable with respect to the bottle part 411 in the attachment/detachment direction.

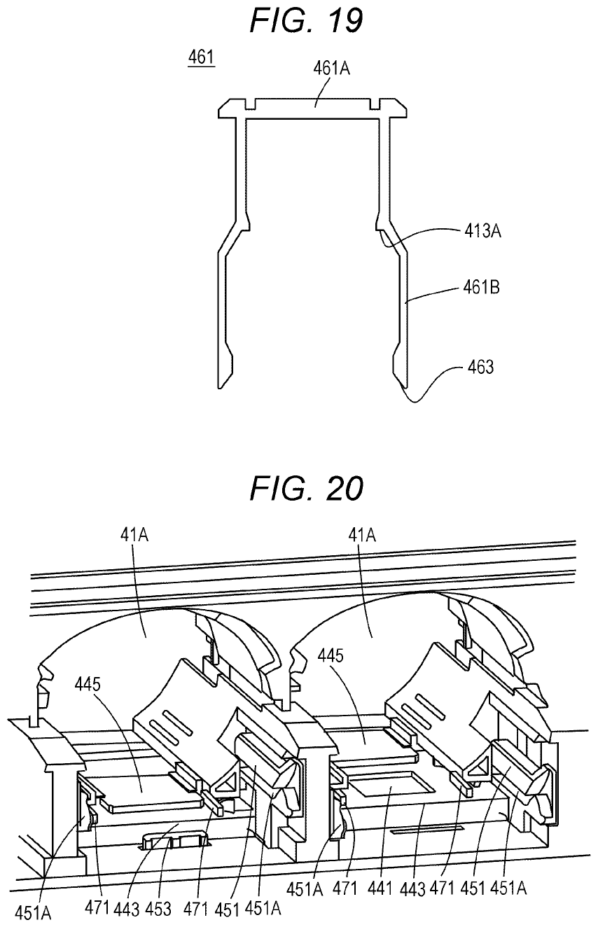

FIG. 19 is a plan view of a regulating member in a state where the second shutter member is at the detachment position. In the drawing, a plan view of the regulating member 461 as viewed from below is illustrated. In FIG. 19, the vertical direction in the drawing is the attachment/detachment direction, the upper side in the drawing is the front direction, and the lower side in the drawing is the rear direction. The regulating member 461 includes a base portion 461A perpendicular to the attachment/detachment direction and a pair of connection members 461B extending in the rear direction from both ends of the base portion 461A. The base portion 461A is fixed to the cap part 412. In the pair of connection members 461B, a locking part 413A is formed at a predetermined distance from an end connected to the base portion 461A, and an inclined surface 463 is formed at an end on the opposite side of the end connected to the base portion 461A. The connection member 461B and the locking part 413A constitute a part of the lock mechanism. The connection member 461B is fixed to the cap part 412 at an end connected to the base portion 461A. The locking part 413A has a locking surface that perpendicularly intersects the attachment/detachment direction. The inclined surfaces 463 respectively formed on the two connection members 461B are respectively formed on surfaces at which the two connection members 461B face each other. Each of the pair of connection members 461B is formed of a member having elasticity. Therefore, in a case where an external force is applied in a direction in which the inclined surfaces 463 are away from each other, the pair of connection members 461B biases the locking parts 413A formed in the respective connection members 461B in a direction in which the locking parts 413A approach each other.

Referring again to FIGS. 17 and 18, the second shutter member 435 in the modification includes a rectangular flat plate-shaped lid member 435A, a pair of gripping parts 435B extending upward from each of two opposing ends of the lid member 435A, and a protruding part 435C extending downward from a lower surface of the lid member 435A. The pair of gripping parts 435B has grooves extending in the attachment/detachment direction formed on the surfaces facing each other.

The bottle part 411 includes a support member 414 disposed below the discharge opening 427 and a shutter regulating part 415 disposed adjacent to the support member 414 on the rear direction side. The support member 414 is located vertically below the discharge opening 427, and a hole 414A having a size equal to or larger than a region obtained by projecting the discharge opening 427 on a horizontal plane vertically below is formed.

A pair of ends 414B of the support member 414 having end surfaces parallel to the attachment/detachment direction enters grooves formed in the pair of gripping parts 435B of the second shutter member 435, and the second shutter member 435 is slidable in the attachment/detachment direction with respect to the support member 414.

As illustrated in FIG. 17, in a state where the second shutter member 435 is located at the detachment position, the movement of the second shutter member 435 in the front direction is regulated by the lock mechanism. The lock mechanism includes the locking parts 413A and the connection members 461B formed in the regulating member 461. Specifically, in the second shutter member 435, the engaging part which is a part of the surface on the front direction side abuts on the locking part 413A of the regulating member 461, and the movement of the second shutter member 435 in the front direction is regulated. The front direction is a direction in which the second shutter member 435 moves from the detachment position to the storage position. In addition, the second shutter member 435 closes the hole 414A formed in the support member 414. Therefore, the toner stored in the bottle part 411 does not leak and fall from the toner storage container 41Y.

As illustrated in FIG. 18, in a state where the second shutter member 435 is located at the storage position, a part of the second shutter member 435 is stored in the internal space of the cap part 412. In addition, the first shutter member 429 opens the discharge opening 427, and the hole 414A formed in the support member 414 is exposed. Since the hole 414A formed in the support member 414 has a size equal to or larger than a region obtained by projecting the discharge opening 427 on the horizontal plane vertically below, the toner falling from the discharge opening 427 of the bottle part 411 passes through the hole 414A and falls downward. Therefore, the toner stored in the bottle part 411 falls from the discharge opening 427 by gravity.

FIG. 20 is an enlarged perspective view illustrating a part of the container storage part in the modification together with peripheral members. FIG. 20 illustrates a part corresponding to the storage opening 41A in which each of the toner storage containers 41Y and 41M of the container storage part 41 in the modification is stored. Referring to FIG. 20, the regulating part 443 is disposed below the storage opening 41A of the container storage part 41, and the regulating claw 453 is disposed on the front direction side of the regulating part 443 at a predetermined distance. The regulating part 443 is a part of the front wall on the front direction side of each of the sub-hoppers 42Y, 42M, 42C, and 42K. The regulating claw 453 is provided to be movable in the vertical direction. The regulating claw 453 is formed integrally with the pair of side guide plates 451. The pair of side guide plates 451 has sliding grooves 451A formed on surfaces facing each other. A pair of guide members 471 is disposed so as to sandwich the regulating claw 453. The pair of guide members 471 is a plate-like member, and is fixed to the container storage part 41 so that the longitudinal direction is parallel to the attachment/detachment direction.

The container storage part 41 has a cylindrical space having a diameter larger than the outer diameter of the toner storage container 41Y. When the user inserts the end of the toner storage container 41Y in the rear direction into the storage opening 41A and pushes the toner storage container 41Y in the rear direction, the toner storage container 41Y enters the container storage part 41. In a state where a part having a predetermined length of the toner storage container 41Y enters the container storage part 41, a direction intersecting the attachment/detachment direction of the toner storage container 41Y is positioned by the container storage part 41.

While the toner storage container 41Y is being inserted into the container storage part 41, the protruding parts 412A (see FIG. 17) formed on the side walls of both side surfaces of the cap part 412 of the toner storage container 41Y enter the sliding grooves 451A formed in the side guide plates 451. Since the toner storage container 41Y moves in the attachment/detachment direction, the protruding parts 412A also move in the attachment/detachment direction along with the movement of the toner storage container 41Y. Therefore, the sliding groove 451A formed in the side guide plate 451 receives a force from the protruding part 412A, and the regulating claw 453 moves in the vertical direction.

The sliding groove 451A is formed in the side guide plate 451 so that the sliding groove 451A is positioned on the lower side until the second shutter member 435 abuts on the regulating part 443 after the toner storage container 41Y enters the container storage part 41, and the regulating claw 453 is positioned on the upper side after the second shutter member 435 abuts on the regulating part 443.

FIG. 20 illustrates a state in which the regulating claw 453 corresponding to the storage opening 41A of the container storage part 41 in which the toner storage container 41Y is stored is located on the upper side, and illustrates a state in which the regulating claw 453 corresponding to the storage opening 41A of the container storage part 41 in which the toner storage container 41M is stored is located on the lower side. Note that FIG. 20 illustrates a state in which the supply opening 441 is opened and a state in which the regulating claw 453 is moved downward in the storage opening 41A of the container storage part 41 in which the toner storage container 41M is stored, however in practically, it is not necessary to realize two states at the same time. When the toner storage container 41Y is stored in the container storage part 41, the regulating claw 453 may move downward only while at least the protruding part 435C provided on the second shutter member 435 moves from the front direction side to the rear direction with respect to the regulating claw 453, and when the toner storage container 41Y is detached from the container storage part 41, the regulating claw 453 may move upward only while at least the second shutter member 435 moves from the storage position to the attachment/detachment position. In addition, the supply opening 441 may be opened only while at least the discharge opening 427 of the toner storage container 41Y is positioned above the supply opening 441.

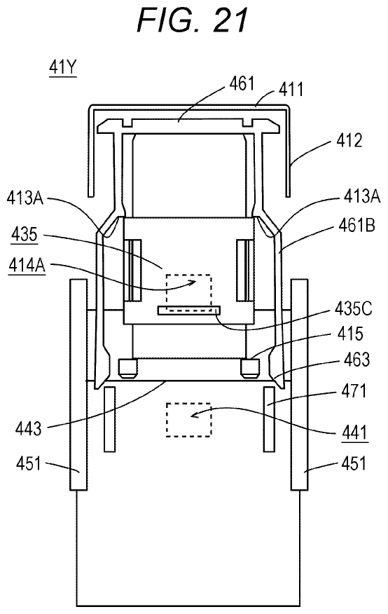

FIGS. 21 to 23 are diagrams illustrating a positional relationship among the regulating member, the second shutter member, and the guide member. FIGS. 21 to 23 are views of the toner storage container 41Y as viewed from below. In FIGS. 21 to 23, the upper side in the drawing is the front direction, and the lower side in the drawing is the rear direction.

FIG. 21 illustrates a positional relationship among the regulating member 461, the second shutter member 435, and the guide member 471 at a stage before the inclined surface 463 of the regulating member 461 comes into contact with the guide member 471. Referring to FIG. 21, the toner storage container 41Y is inserted into the container storage part 41 by the user from the front side in the rear direction. FIG. 21 illustrates a state before the inclined surface 463 of the regulating member 461 comes into contact with the guide member 471. In this state, since the locking part 413A formed in the regulating member 461 is abutting on the engaging part which is a part of the side surface on the front direction side of the second shutter member 435, the second shutter member 435 is regulated from moving in the front direction with respect to the bottle part 411 and is fixed at the detachment position.

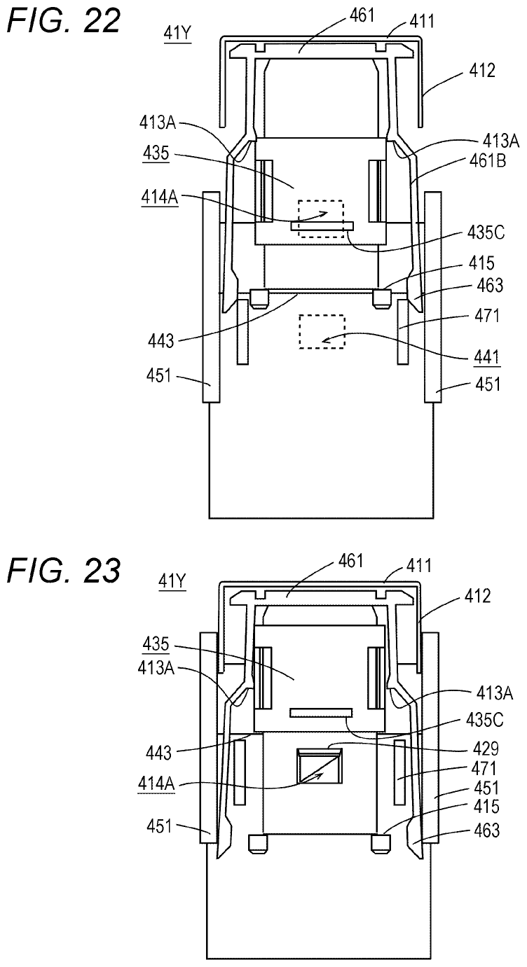

FIG. 22 illustrates a positional relationship among the regulating member 461, the second shutter member, and the guide member 471 at a stage immediately after the inclined surface 463 formed in the regulating member 461 comes into contact with the guide member 471. In FIG. 22, the upper side in the drawing is the front direction, and the lower side in the drawing is the rear direction. FIG. 22 illustrates a state in which the toner storage container 41Y is pushed in the rear direction by the user from the state illustrated in FIG. 21. When the toner storage container 41Y is pushed in the rear direction by the user from the state illustrated in FIG. 21, the inclined surface 463 formed in the regulating member 461 abuts on the guide member 471, and the inclined surface 463 receives a force in the front direction from the guide member 471. As a result, the connection member 461B is elastically deformed, the distance between the pair of connection members 461B increases, and the pair of locking parts 413A is not engaged with the engaging part of the second shutter member 435. Since the direction intersecting the attachment/detachment direction of the toner storage container 41Y is positioned by the container storage part 41, the inclined surface 463 formed in the connection member 461B reliably abuts on the guide member 471. Therefore, the second shutter member 435 can move from the detachment position to the storage position.

Further, when the toner storage container 41Y is pushed in the rear direction by the user, the second shutter member 435 abuts on the regulating part 443. Since the direction intersecting the attachment/detachment direction of the toner storage container 41Y is positioned by the container storage part 41, the second shutter member 435 reliably abuts on the regulating part 443. Since the movement of the second shutter member 435 relative to the container storage part 41 is regulated by the regulating part 443, when the toner storage container 41Y is further pushed by the user in the rear direction, the second shutter member 435 starts to move from the detachment position to the storage position.

While the second shutter member 435 moves from the detachment position to the storage position, the surface of the connection member 461B facing the second shutter member 435 moves while being in contact with the guide member 471. During this time, the elastic deformation of the connection member 461B is maintained, and the state in which the locking part 413A is biased in the direction toward the second shutter member 435 is maintained.

FIG. 23 illustrates a positional relationship among the regulating member 461, the second shutter member 435, and the guide member 471 in a state where the toner storage container 41Y is stored in the container storage part 41. In FIG. 23, the upper side in the drawing is the front direction, and the lower side in the drawing is the rear direction. When the toner storage container 41Y is pushed in the rear direction by the user and stored in the container storage part 41, the movement of the second shutter member 435 is regulated by the regulating part 443, so that the second shutter member 435 moves to the storage position.

Referring to FIG. 23, the hole 414A of the support member 414 is exposed in a state where the second shutter member 435 is at the storage position. In a state where the toner storage container 41Y is stored in the container storage part 41, the hole 414A of the support member 414 vertically overlaps the supply opening 441 of the sub-hopper 42Y. Apart of the second shutter member 435 is stored in the internal space of the cap part 412. While the second shutter member 435 moves from the detachment position to the storage position, the second shutter member 435 abuts on the connection member 461B of the regulating member 461, so that the two connection members 461B are elastically deformed and pushed out by the second shutter member 435. While the connection member 461B abuts on the second shutter member 435, the state in which the two locking parts 413 A are biased by the connection member 461B in the direction toward the second shutter member 435 is maintained.

As described above, the toner storage container 41Y in the present embodiment is detachable from the MFP 100 that functions as an image processing apparatus. The toner storage container 41Y includes: the bottle part 411 that stores toner; the discharge opening 427 that opens the bottle part 411 to the outside; the first shutter member 429 that is rotatably attached to the bottle part 411 between a closed position where the discharge opening 427 is closed and an open position where the discharge opening is opened; the second shutter member 435 that is provided to be relatively movable with respect to the bottle part 411 in the attachment/detachment direction in which the second shutter member 435 is attached to or detached from the MFP 100 between a storage position separated from the first shutter member 429 at the open position and a detachment position in contact with the first shutter member 429 at the closed position; and the lock mechanism that regulates movement of the second shutter member 435 at the detachment position from the detachment position. The lock mechanism includes the connection member 437 having the inclined surface 438 inclined with respect to the attachment/detachment direction in a state where the second shutter member 435 is located at the storage position.

The second shutter member 435 is separated from the first shutter member 429 at the storage position, the first shutter member 429 is at the open position, and the discharge opening 427 of the bottle part 411 is opened. The second shutter member 435 comes into contact with the first shutter member 429 at the detachment position, the first shutter member 429 is at the closed position, and the discharge opening 427 of the bottle part 411 is closed. When the second shutter member 435 is located at the detachment position, the movement of the second shutter member 435 from the detachment position is regulated by the lock mechanism. In a case where the second shutter member 435 is located at the detachment position, since the connection member 437 included in the lock mechanism has the inclined surface 438 inclined with respect to the attachment/detachment direction, when a force in the attachment/detachment direction is applied to the inclined surface 438, the connection member 437 moves in a direction intersecting the attachment/detachment direction, and the regulation by the lock mechanism is released. Therefore, by applying a force in the attachment/detachment direction in which the toner storage container 41Y is attached to and detached from the MFP 100 to the second shutter member 435, it is possible to perform regulation of movement of the second shutter member 435 and release of the regulation in addition to opening and closing of the discharge opening 427. Therefore, it is possible to store the toner storage container 41Y in which the toner that falls down while the toner storage container 41Y is not being stored in the MFP 100 is reduced in the MFP 100 by applying a force in the attachment/detachment direction to the toner storage container 41Y.

In addition, the lock mechanism further includes: the locking part 413 that is fixed to the bottle part 411 on an outer side of a track on which the second shutter member 435 moves in the attachment/detachment direction; and the engaging part 439 that engages with the locking part 413 in a state where the second shutter member 435 is located at the detachment position, and the connection member 437 is provided between the engaging part 439 and the second shutter member 435 and biases the engaging part 439 in a direction away from the second shutter member 435. The locking part 413 is fixed to the bottle part 411 outer side the track of the second shutter member 435, and the engaging part 439 is biased in a direction away from the second shutter member 435 by the connection member 437, so that the engaging part 439 is biased by the locking part 413. Therefore, the engaging part can be engaged with the locking part.

In addition, the inclined surface 438 has a longer distance from the second shutter member 435 at a part located in a direction in which the second shutter member 435 goes from the detachment position toward the storage position. Therefore, when the inclined surface 438 receives a force in the attachment/detachment direction, the connection member 437 is elastically deformed by receiving a force in a direction intersecting the attachment/detachment direction, and the engaging part 439 approaches the second shutter member 435. Therefore, since the engaging part 439 is not engaged with the locking part 413, the regulation on the movement of the second shutter member 435 from the detachment position can be released.

In addition, the engaging part 439 and the connection member 437 are formed of the same member as the second shutter member 435. Therefore, a simple configuration can be obtained, and manufacturing is easy.

The engaging parts 439 are provided on both sides of the second shutter member 435 while sandwiching the second shutter member 435. Therefore, the second shutter member 435 can be stably fixed at the detachment position.

In addition, the engaging part 439 is formed on a sliding surface facing a surface facing the second shutter member 435, and has sliding surfaces 439B and 439C and an engaging surface 439A intersecting the sliding surfaces 439B and 439C. Among the two sliding surfaces 439B and 439C sandwiching the engaging surface 439A in the attachment/detachment direction, the sliding surface 439B located in a direction in which the second shutter member 435 moves from the detachment position to the storage position has a shorter distance from the second shutter member 435 in a state where the second shutter member 435 is located at the detachment position. Therefore, the engaging part 439 can be engaged with the locking part 413.

In the toner storage container 41Y in the modification, the lock mechanism is formed of a member different from the second shutter member 435. The lock mechanism includes a locking part 413A provided on the side of the discharge opening 427 in the direction in which the second shutter member 435 moves from the detachment position to the storage position, and a connection member 461B having an inclined surface 463 inclined with respect to the attachment/detachment direction in a state in which the second shutter member 435 is located at the storage position, fixed to the bottle part 411, and biasing the locking part 413A toward a track on which the second shutter member 435 moves in the attachment/detachment direction. Therefore, since the locking part 413A enters the track of the second shutter member 435 on the side of the discharge opening 427 in the direction in which the second shutter member 435 goes from the detachment position to the storage position, the movement of the second shutter member 435 in the direction from the detachment position toward the storage position can be regulated on the side of the discharge opening 427 in the direction from the detachment position toward the storage position.

In addition, when the second shutter member 435 is located at the detachment position, the connection member 461B included in the lock mechanism has the inclined surface 463 inclined with respect to the attachment/detachment direction, and the inclined surface 463 has a shorter distance from the track at a part located in a direction in which the second shutter member 435 goes from the detachment position to the storage position. Therefore, when the inclined surface 463 receives a force in the attachment/detachment direction, the locking part 413A overcomes the elastic force of the connection member 461B and moves to the outer side of the track of the second shutter member 435. For this reason, since the second shutter member 435 can move from the detachment position, the regulation on the movement of the second shutter member 435 from the detachment position can be released. Therefore, by applying a force in the attachment/detachment direction in which the toner storage container 41Y is attached to and detached from the MFP 100 to the second shutter member 435, it is possible to perform regulation of movement of the second shutter member 435 and release of the regulation in addition to opening and closing of the discharge opening 427. Therefore, it is possible to store the toner storage container 41Y in which the toner that falls down while the toner storage container 41Y is not being stored in the MFP 100 is reduced in the MFP 100 by applying a force in the attachment/detachment direction to the toner storage container 41Y.

In addition, the locking part 413A has a locking surface that abuts on the second shutter member 435 located at the detachment position. Therefore, since the locking surface of the locking part 413A abuts on the second shutter member 435, the movement of the second shutter member 435 can be stably regulated.

The MFP 100 functioning as an image forming apparatus includes: a container storage part 41 to which the toner storage container 41Y is detachably attached and which has a storage opening 41A and stores the toner storage container 41Y; a regulating part 443 that is disposed on the side of the storage opening 41A in the direction in which the second shutter member 435 moves from the detachment position to the storage position and abuts on the second shutter member 435; a side guide plate 451 that is disposed on the side of the regulating part 443 in the direction in which the second shutter member 435 moves from the detachment position to the storage position and abuts on the inclined surface 438; and a guide member 471 that abuts on the inclined surface 463 in the modification. Before the toner storage container 41Y is stored in the container storage part 41, the second shutter member 435 abuts on the regulating part 443, and before the second shutter member 435 abuts on the regulating part 443, the side guide plate 451 abuts on the inclined surface 438, and in the modification, the guide member 471 abuts on the inclined surface 463. Therefore, before the second shutter member 435 abuts on the regulating part 443, the regulation on the movement of the second shutter member 435 from the detachment position to the storage position is released. Therefore, the MFP 100 can store the toner storage container 41Y by moving the toner storage container 41Y in one direction with less toner falling down.

In addition, the container storage part 41 includes a positioning part that positions the toner storage container 41Y in a direction intersecting the attachment/detachment direction. When the toner storage container 41Y is stored in the MFP 100, since the toner storage container 41Y is positioned in the direction intersecting the attachment/detachment direction, the side guide plate 451 can reliably abut on the inclined surface 438, and in the modification, the guide member 471 can reliably abut on the inclined surface 463.

Further, a cover member 50 that opens and closes the storage opening 41A is further included, and the cover member 50 is disposed on the side of the side guide plate 451 in the direction in which the second shutter member 435 moves from the detachment position to the storage position in the state where the storage opening 41A is opened, and in the modification, the cover member 50 is disposed on the side of the guide member 471 in the direction in which the second shutter member 435 moves from the detachment position to the storage position. Therefore, when the toner storage container 41Y is stored in the MFP 100, the movement of the second shutter member 435 is regulated until the second shutter member 435 passes above the cover member 50 in the vertical direction, so that it is possible to reduce the toner falling down on the cover member 50.

It should be understood that the embodiments disclosed herein are illustrative in all respects and not restrictive. The scope of the present invention is indicated not by the above description but by the claims, and it is intended that meanings equivalent to the claims and all modifications within the scope are included.

<Supplementary Note>

(1) The toner storage container according to claim 6, wherein the sliding surface having a shortest distance from the second shutter member in a state where the second shutter member is located at the detachment position has a predetermined length in the attachment/detachment direction. According to this aspect, since the sliding surface having the shortest distance from the second shutter member has the predetermined length in the attachment/detachment direction, it is possible to maintain a state in which the engaging part is engaged with the locking part.

Although embodiments of the present invention have been described and illustrated in detail, the disclosed embodiments are made for purposes of illustration and example only and not limitation. The scope of the present invention should be interpreted by terms of the appended claims.

What is claimed is:

1. A toner storage container detachable from an image forming apparatus, the toner storage container comprising:
a bottle part that stores toner;
a discharge opening that opens the bottle part to the outside;
a first shutter member that is rotatably attached to the bottle part between a closed position where the discharge opening is closed and an open position where the discharge opening is opened;
a second shutter member that is provided to be relatively movable with respect to the bottle part in an attachment/detachment direction in which the second shutter member is attached to or detached from the image forming apparatus between a storage position separated from the first shutter member at the open position and a detachment position in contact with the first shutter member at the closed position; and
a lock mechanism that regulates movement of the second shutter member at the detachment position from the detachment position, wherein
the lock mechanism includes a connection member having an inclined surface inclined with respect to the attachment/detachment direction in a state where the second shutter member is located at the storage position.

2. The toner storage container according to claim 1, wherein
the lock mechanism further includes:
a locking part that is fixed to the bottle part on an outer side of a track on which the second shutter member moves in the attachment/detachment direction; and
an engaging part that engages with the locking part in a state where the second shutter member is located at the detachment position, and
the connection member is provided between the engaging part and the second shutter member, and biases the engaging part in a direction away from the second shutter member.

3. The toner storage container according to claim 2, wherein the inclined surface has a longer distance from the second shutter member at a part located in a direction in which the second shutter member goes from the detachment position to the storage position.

4. The toner storage container according to claim 2, wherein the engaging part and the connection member are formed of the same member as the second shutter member.

5. The toner storage container according to claim 2, wherein the engaging parts are provided on both sides of the second shutter member while sandwiching the second shutter member.

6. The toner storage container according to claim 2, wherein
the engaging part has an engaging surface formed on a sliding surface facing a surface of the connection member facing the second shutter member and intersecting the sliding surface, and
among the two sliding surfaces sandwiching the engaging surface in the attachment/detachment direction, the sliding surface located in a direction in which the second shutter member moves from the detachment position to the storage position has a shorter distance from the second shutter member in a state where the second shutter member is located at the detachment position.

7. The toner storage container according to claim 1, wherein
the lock mechanism includes a locking part provided on a side of the discharge opening in a direction in which the second shutter member goes from the detachment position to the storage position, and
the connection member is fixed to the bottle part, and biases the locking part toward a track on which the second shutter member moves in the attachment/detachment direction.

8. The toner storage container according to claim 7, wherein the inclined surface has a shorter distance from the track at a part located in a direction in which the second shutter member goes from the detachment position to the storage position.

9. The toner storage container according to claim 7, wherein the connection member is formed of a member different from the second shutter member.

10. The toner storage container according to claim 7, wherein the locking part has a locking surface that abuts on the second shutter member located at the detachment position.

11. An image forming apparatus to which the toner storage container according to claim 1 is detachable, the image forming apparatus comprising:
a container storage part that has a storage opening and stores the toner storage container; and
a regulating part that is disposed on a side of the storage opening in a direction in which the second shutter member moves from the detachment position to the storage position and abuts on the second shutter member; and
a guide member that is disposed on a side of the regulating part in a direction in which the second shutter member moves from the detachment position to the storage position and abuts on the inclined surface.

12. The image forming apparatus according to claim 11, wherein the container storage part includes a positioning part that positions the toner storage container in a direction intersecting the attachment/detachment direction.

13. The image forming apparatus according to claim 11, further comprising
a cover member that opens and closes the storage opening, wherein
the cover member is disposed on a side of the guide member in a direction in which the second shutter member moves from the detachment position to the storage position in a state where the storage opening is opened.
